(19) United States
(12) Patent Application Publication
(10) Pub. No.: US 2005/0097049 A1
(43) Pub. Date: May 5, 2005

(54) Methods for verifying cardholder authenticity and for creating billing address database

(76) Inventors: Shea Writer, Wilmington, NC (US); Bernhard Rudolph, Innsbruck (AT)

Correspondence Address: SETTER OLLILA, LLC, 2060 BROADWAY, SUITE 300, BOULDER, CO, 80302, US

(21) Appl. No.: 10/486,026

(22) PCT Filed: Aug. 14, 2002
(86) PCT No.: PCT/US02/25785

Related U.S. Application Data
(60) Provisional application No. 60/312,644, filed on Aug. 15, 2001.

(51) Int. Cl. G06F 17/60

(52) U.S. Cl. 705/44

(57) ABSTRACT

Methods and associated structure for verifying the identity of a consumer in a financial card transaction. The method provides for issuing at least one authorization request through standard card transaction networks and protocols. The amount of each transaction and/or the number of transactions is preferably randomly generated. If the purported cardholder confirms the random amounts and or number of transactions the purported cardholder is identified as an authorized cardholder. The authorized transactions are never captured (completed) and hence are removed by the issuing institution in accordance with the institutions rules for the account. Since the transactions are never captured, no funds are transferred to or from the card holder's account by virtue of the verification process. Further, the transactions are communicated to the institution using standard networks and protocols available from all card-issuing (or servicing) institutions and available to all merchants that accept cards for customer purchases. Still further, the same method may be used for verifying cardholder identity in both debit and credit card proposed transactions within a near-real-time environment. A further aspect of the invention provides for verifying an e-mail address associated with the verified authorized cardholder. The verified card account information and the associated, verified e-mail address of the cardholder is recorded in a database of a secured server. A merchant confronted with a proposed transaction using a card account may request verification from the secured server. An e-mail message is sent to the verified cardholder at the verified e-mail address. The cardholder's reply then accepts of rejects the proposed card transaction.

The present convention relates generally to electronic commerce systems and more specifically relates to credit/debit card authorization and verification coupled with the utilization and generation of a local billing and consumer identification verification database.

In commercial transactions utilizing credit cards and debit cards (collectively referred to herein as “financial cards”), merchants are generally required to obtain authorization for charging a particular transaction. In general, such authorization is obtained by communicating with the bank (or other issuing institution) and obtaining oral or electronic authorization to transact a particular amount on behalf of the customer. Should a transaction receive authorization, the decision to complete (or “capture”) the transaction falls to the merchant and depends largely on whether or not the merchant is able to sufficiently verify the identity of the consumer. In face-to-face transactions, merchants will often require the consumer's hand-written signature—confirmed by a picture ID. When conducting transactions over an electronic network such as the Internet, such traditional means of identity verification are not available.

At present, the most widely used verification system used to determine cardholder identity for such “card not present” (i.e., Internet) transactions is the Address Verification Service (also referred to herein as “AVS”). AVS is a proprietary system offered and supported by the major credit card companies as a method of verifying the cardholder's billing address—thereby assisting merchants in the identifying of possible credit card fraud. In general, a merchant may require entry of the consumer's billing address along with the consumer's credit card number. These two elements of information are then electronically or orally conveyed via the AVS system to the issuing institution for the purpose of verifying the cardholder's billing address. If the known the billing address matches the address provided by the consumer, the merchant may then make an informed decision as to whether or not to accept the consumer's transaction.

The AVS system is neither mandatory nor imposed on merchants. Rather, it is merely a source of information for merchants to use to gain confidence that the proposed credit card transaction is not fraudulent. Despite the fact that the AVS system verifies the consumer's address, the merchant may still reject the consumer's proposed transaction for other reasons. Similarly, despite the fact that the AVS system may not match the consumer's supplied address, the merchant may accept the proposed credit card transaction and risk the possibility of fraud.

Further it should be noted that the AVS system is voluntary on the part of issuing institutions. Not all institutions that issue credit/debit cards choose to participate in the AVS system. Though all banks have a significant incentive to assist their merchants reduce their exposure to credit card fraud, several U.S. banks and a majority of international banks choose not to participate in the technically complex AVS system. Merchants accepting credit card transactions from credit cards issued by banks that do not participate in AVS are often forced to make final transaction decisions without significant verification information available.

A number of prior solutions have sought to address the problem of inconsistently available verification information from card-issuing institutions. In general, such solutions provide an external (i.e., third party) source of verification information—i.e., independent of the issuing institution decision to provide AVS services.

At least one technique (known commercially as “Verified By VISA™”) simply requires each cardholder to call their issuing bank and assign a PIN (personal identification number or password) to their card. The PIN is not imprinted on the card. The issuing institution is then able to verify the registered PIN when requested to do so by a merchant attempting to verify a consumer's transaction. This method still requires the issuing institution to cooperate in that each institution must associate PINs with their issued cards and independently provide the accompanying verification service for merchants.

Another solution exemplified by U.S. Pat. No. 6,282,658 attempts to verify a user's identity by comparing user input to a database of known user information. This method presents a paradigm wherein a user is asked questions to verify the user's identity. The teachings are not as specifically directed to verification of a cardholder's identity by a merchant confronted with a proposed transaction by a consumer in possession of the card number.

Another solution typified by U.S. Pat. No. 6,029,154 provides for verifying a proposed card transaction by a number of weighted factors relating to history of past transactions with the card. This proposed solution teaches analysis of past known transactions to determine the similarity of the present proposed transaction with historical trends. A closely related solution in U.S. Pat. No. 6,108,642 requires information from the user regarding a second, related card number to compare the proposed transaction to prior recorded transaction information relating to both card numbers.

In yet another solution, recent proposals have suggested determining an individual's geographic location from the IP address of the client process attempting an online transaction using a credit/debit card. The location so determined can be used to identify clear cases of fraud in that the same card may not be used in multiple locations around the world at nearly the same time.

A significant number of prior techniques use “biometric” information to verify the user identity in a proposed card transaction. A specialized writing implement measuring various attributes of the signature writing process as well as fingerprint sensors is provided that determines a match or no match of the signature (U.S. Pat. No. 6,307,956). Another proposes a speech recognition system to recognize the user's identity from a spoken key phrase such as the card number, a PIN or password (U.S. Pat. No. 6,292,782). Still another combines voice recognition and video parameter recognition to verify the identity of a user for purposes of a secured transaction (U.S. Pat. No. 6,219,639).

A number of present solutions apply digital encryption in the form of “certificates” or “smartcards” to enhance verification of a user's identity or of a transaction. See for example U.S. Pat. Nos. 6,125,349 and 5,590,197. Several such prior solutions are focused on verification of details of a particular transaction as opposed to verification of the user's identity in any transaction. See for example U.S. Pat. Nos. 6,226,624, 5,991,411 and 5,988,497.

One present solution applies one of two different methods to enable verification of a consumer's identity. PayPal utilizes techniques to verify a user's identity for transaction on checking accounts or with a credit card. In concept the techniques vary only slightly but each method essentially completes (i.e., captures) small transactions on the user's account and ask the user to verify the results of the completed transactions. Technically each method relies on different systems for verification of the amounts. Information regarding PayPal accounts and methods is available from their Web site at http://www.paypal.com.

To verify the identity of a checking account holder's transaction, PayPal issues two transactions that result in two small deposits to the user's checking account. The two deposits are each for random values less than $1.00. PayPal then instructs the checking account holder to confirm the amount of the two small deposits. If the user verifies the amount of the two deposits, the user is presumed to be the proper owner of the bank account (presuming that the bank would only divulge such information to the rightful owner of the account). PayPal is able to accomplish this method by utilizing a standard for bank communications involving a private banking network and associated protocols maintain by Automated Clearing House (ACH). These deposit transactions complete actual money transfers from the accounts of PayPal to the account of a new user (though a small amount). PayPal intends that the user will keep the deposited dollar as a byproduct of starting a PayPal account. Principally however, the deposits are needed for PayPal to perform the requisite authorization. This cost associated with the PayPal system can be significant in cash flow terms—even though the investment may be recouped many fold through ongoing subsequent transactions.

This method used by PayPal relies on the ACH proprietary networks and protocols and is therefore not specifically applicable to verification of a user's identity in a credit card transaction.

To verify the identity of a credit cardholder, PayPal completes a similar “transfer of money” transaction (but in reverse) by charging the purported user's credit card account for $1.95. In technical detail, such a transaction is actually performed as a three-step process. First the account is “authorized” for a $1.95 charge (to make sure that the funds are available) and then the authorization is “captured” to complete the “transfer of money” transaction. Such captured (completed) transactions will then appear on the user's next monthly statement for the account (while incomplete transaction would not appear on the end-of-month billing statement). In the description field (“descriptor”) of the captured transaction, PayPal includes a dynamically generated ID number and asks the user to verify that ID number as a third step in the process. If the user properly verifies the generated ID number found on the billing statement in the capture's descriptor, the user is presumed to be the owner of the account by knowledge derived from the captured transaction appearing on monthly statement.

This generated ID number is not usually available on the user's credit card account for 1-3 business days (and up to several weeks in the case of “international” cards). For this reason, PayPal is often unable to immediately (i.e., at the point of sale) authenticate a cardholder's identity as the cardholder must wait for the captured transaction to be posted to their account to retrieve the generated descriptor ID and hence authenticate their identity for PayPal.

Further, PayPal actually completes (captures) the charge transaction to the user's credit card account. The cardholder is therefore actually responsible for initially paying the $1.95 charge. PayPal later refunds the cardholder for this charge. However, the process of an initial capture and eventual credit/refund amount to two, unique transaction services results in service fees generally billed to PayPal by the card institution (i.e., the merchant in the eyes of the card institution).

In terms of cost, time and general efficacy, it is evident from the above discussion that a need exists for improved verification techniques to quickly verify the identity of a cardholder in a debit or credit card “card not present” transaction.

### Solution

The present invention solves the above and other problems, thereby advancing the state of the useful arts, by providing methods and associated structure for rapidly verifying the identity of a cardholder for both debit and credit “card not present” transactions without actual transfer of funds in or out of the cardholder's account in the verification process and without requiring a restructuring of industry protocols or splintered institutions to independently adopt and integrate new service technologies. More specifically, the present invention provides for an effective method for verifying the cardholder's identity that may be used for both debit card and credit card proposed transactions. In one aspect of the invention, a method provides for authorizing, but not capturing or completing, one or more transactions of randomly generated amounts used as a temporary identification. Such “authorizations” occur in near-real-time in that they on temporary banking records that are almost immediately available for the cardholder's reference and confirmation. The consumer (purported cardholder) is then instructed to contact their bank or other issuing institution to obtain the amounts of the authorized, incomplete transactions. If the customer correctly verifies the amounts (i.e., verifies the temporary identification code), the user may be presumed to be the cardholder by virtue of access to the secured information obtained from the bank (or other card-issuing institution).

Such a method of the present invention is usable over industry standard, open networks accessible to all merchants and supported by all card-issuing/servicing institutions. Since the transactions are authorized but never captured (completed), no money is actually transferred to or from the cardholder's account. Rather, the authorized amounts on the account merely expire as incomplete transactions. The transactions are preferably of relatively small amounts so as to avoid unnecessary encumbrance of the account.

Another aspect of the present invention combines the above verification technique with e-mail verification to provide a low cost, easily accessed online verification technique for post-authenticated account transactions. A cardholder creates an account under the present invention by logging into a secure server site and supplying three elements of information—an e-mail address, a debit or credit card number for an account (with expiration date) and a postal address for billing/statements on the account. If the card account is unknown to the server site (not previously recorded in its local database), the above method is first used to verify a cardholder's identity. This step verifies the user as an authorized cardholder. Next, an e-mail verification is sent to the supplied e-mail account asking the user to reply to the e-mail message with an independently supplied verification ID code. This step verifies the user as the owner of the e-mail account (i.e., one with access to the e-mail account). With these verifications complete the information is entered into the server's database.

When a purchase transaction is proposed using the previously authenticated card account, the merchant may request verification of the proposed transaction from the server site. Verification is performed by transmitting an e-mail message to the verified e-mail account associated with the card in the server's database. The e-mail message preferably provides the cardholder with the details of the proposed transaction along with a transaction ID (i.e., PIN or other temporary identification code information) and requests the user to reply to the e-mail with acceptance or rejection of the proposed transaction. Since the e-mail address has been verified as belonging to the verified cardholder, the acceptance or rejection of the specified transaction ID may be presumed as a valid response from the verified cardholder. The response is then returned to the merchant for further processing of the transaction.

### BRIEF DESCRIPTION OF THE DRAWINGS

FIG. 1 is a flowchart describing a method of the present invention operable to verify the identity of a purported cardholder.

FIG. 2 is a flowchart describing a method of the present invention operable to verify an e-mail address to be associated with an authorized cardholder of a card account.

FIG. 3 is a flowchart of a method of the present invention operable to verify a particular purchase transaction using the verified account and e-mail information determined in accordance with methods of the present invention.

FIG. 4 is a block diagram of systems and data flow there between for systems involved in purchase transaction in accordance with the methods of the present invention.

FIG. 5 is a block diagram of systems and data flow there between for systems involved in verification of a purported cardholder's identity as an authorized cardholder in accordance with the present invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

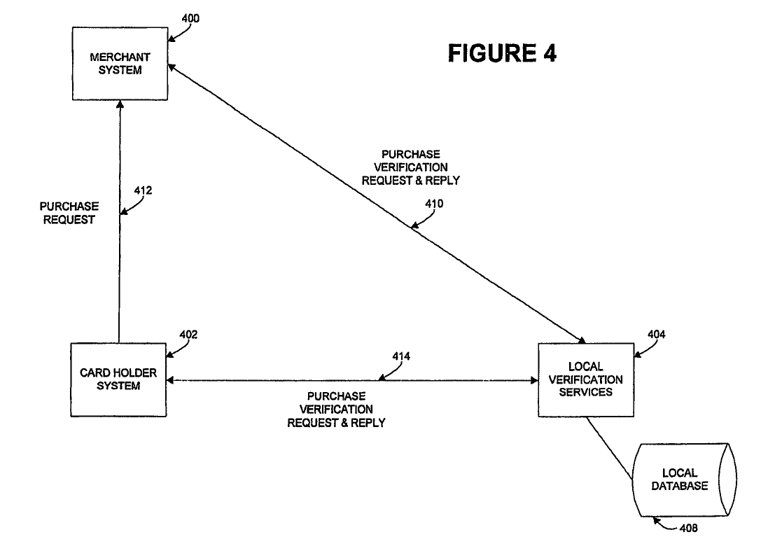

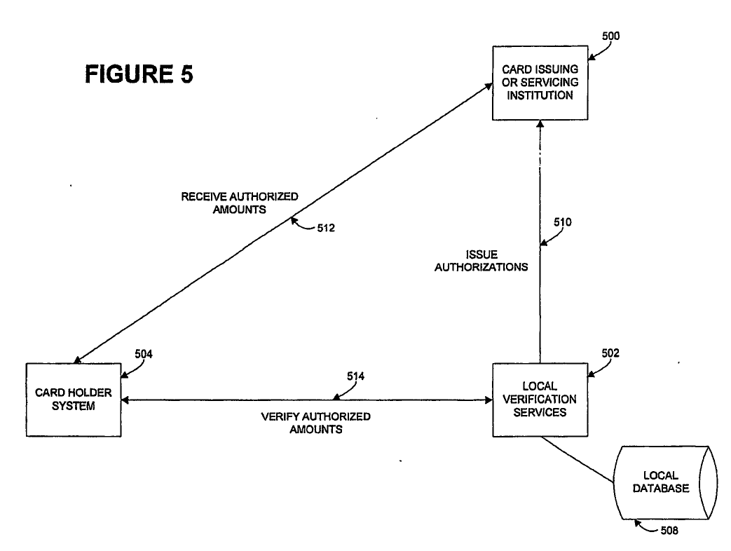

FIGS. 4 and 5 are block diagrams depicting systems in which methods of the present inventions are operable and also depicting data flow between the various systems. Those skilled in the art will readily recognize any number of system configurations and interconnection topologies that may be used for each depicted system and communication path of FIGS. 4 and 5. In particular, each “system” may be a computing device, a point-of-sale transaction device, etc. Further, the paths interconnecting the various systems may utilize any number of equivalent communication techniques including computer to computer network processing, wide area network connections such as the Internet, proprietary private networks, voice communications, etc. The block diagrams of FIGS. 4 and 5 are therefore intended as representative of a broad class of system configurations, devices, and interconnecting communications media all of which are well-known matters of design choice to those of ordinary skill in the art.

In particular, FIG. 5 depicts the systems and data flow involved in constructing and maintaining local verification services 502 and its associated database 508. In particular, upon request of a cardholder or merchant (not shown), local verification services 502 attempts to verify the identity of a purported cardholder. In particular, in an exemplary preferred embodiment, local verification services 502 issues authorization requests for one or more authorizations the total amount of which equals some predetermined value. In one exemplary preferred embodiment, two authorizations are generated each having an amount greater than one dollar but less than two dollars (i.e., enough to insure infrastructure recognition and acceptance of the individual authorizations but not so much as to unnecessarily, though temporarily, burden the account).

Those skilled in the art will recognize that any number of transactions may be issued so long as the account is not unnecessarily burdened. Further the total amount of such transactions may be any amount again so long as the account is not unnecessarily burdened. The purpose is to randomize the total amount and/or number of transactions so as to preclude a fraudulent card account user from guessing at the verification information. The randomly selected amount of each transaction and/or the total amount therefore serves as temporary identification code to permit electronic, near-real-time verification of the card user as an authorized cardholder.

The authorization requests so generated are issued via path 510 to the card-issuing or servicing institution 500. Processing of such authorization requests are standard features available from every institution supporting debit or credit cards. Path 510 may be any communication medium and protocol suitable to communicate authorization requests to a card-issuing or servicing institution. For example, the Internet, proprietary computer network communications and telephonic communications may be used for this purpose. It will be noted that authorization requests do not actually transfer any funds to or from the cardholder's account. Rather, the verification request, if never completed or captured, is merely deleted after a predetermined time by the systems of the card-issuing or servicing institution.

Following issuance of the plurality of authorization requests to the card-issuing or servicing institution, the purported cardholder is directed to verify the amount of each of the individual authorization requests. Path 514 from local verification services 502 to cardholder system 504 is used to so direct the cardholder. As above, path 514 may utilize any appropriate communication medium and protocol for this intended purpose including computer network communications and voice communications. The cardholder system 504 then requests and receives the individual amounts for each authorization request. The request and receipt of such information via path 512 from card-issuing or servicing institution 500 is a standard feature available from any card-issuing or servicing institution for an authorized user or holder of a particular card. As above, numerous equivalent communication media and protocols may be used for exchange of this information. In receipt of the proper amounts of each authorization request, the cardholder system returns in the proper amounts via path 514 to the local verification services 502. In response to receipt of the proper amounts from the cardholder system 504, local verification services 502 is assured that the purported cardholder is in fact that a properly authorized cardholder or user in accordance with the rules of the card-issuing or servicing institution. This verified information is then stored in database 508 maintained by local verification services 502.

FIG. 4 depicts systems involved in verification of a particular purchase transaction based upon previously verified financial account in conjunction with a previously authenticated e-mail account. More specifically, a cardholder system 402 initiates a purchase request via path 412 directed to a merchant system 400. As noted above, the cardholder's system 402 and merchant system 400 and the communication between the two may be implemented by any of a variety of equivalent devices, topologies, and communications media. For example, the systems may be computing systems communicating via a wide area network such as the Internet or standard point-of-sale devices and communication where a purchaser (purported cardholder) and merchant communicate orally either in person or over a telephone. The merchant system 400 then requests verification of the purchase transaction from local verification services system 404 via path 410. Local verification services 404 inspects database 408 to determine the authenticated e-mail account for the cardholder of the authenticated card account. An e-mail message is generated by local verification services 404 and sent via the path 414 to the cardholder's system 402. The authorized cardholder (or authorized user of the verified e-mail account) then replies to the transmitted e-mail message via path 414 indicating acceptance or rejection of the proposed purchase transaction. The received reply indicating acceptance or rejection is then conveyed via path 410 from the local verification services 404 back to the merchant system 400. Merchant system 400 then makes a determination as to whether or not to complete the proposed purchase transaction.

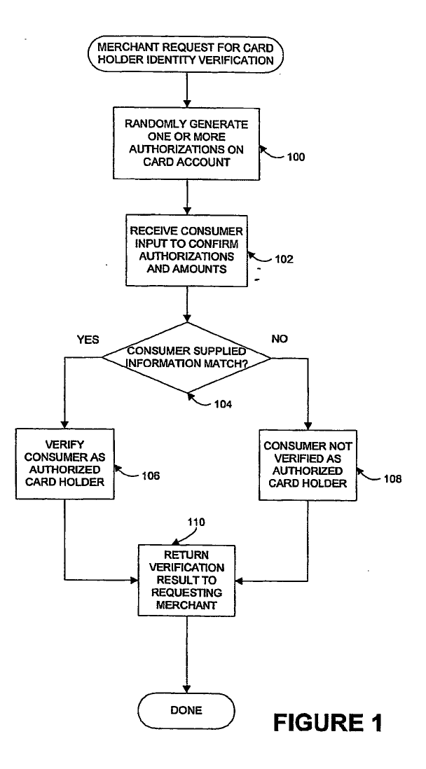

FIGS. 1 through 3 describe methods of the present inventions operable in the various systems of FIGS. 4 and 5. In particular, FIG. 1 is a flowchart describing operation of the method of the present inventions whereby a local verification server is requested to verify the identity of a purported cardholder. Typically, such a request is initiated by a merchant system to verity the identity of a purchaser as an authorized cardholder or user. The method of FIG. 1 is therefore preferably operable within local verification services system such as depicted in FIGS. 4 and 5.

Element 100 is first operable to generate a plurality of authorization requests and to transmit the requests to the card-issuing or servicing institution. Processing of authorization requests is a standard feature available from most card-issuing and servicing organizations to permit merchants to verify sufficient credit is available in the purchaser's card account to complete the proposed transaction. As noted above, in one exemplary preferred embodiment, two transactions are randomly generated totaling some predetermined amount. Those skilled in the art will recognize that any number of requests may be generated totaling any selected predetermined amount. Key to the invention is some randomizing of the amounts and/or the number of transactions so that an unauthorized user cannot simply guess at the correct values when verifying the transactions (as discussed further herein below). It is further key that the authorized transaction amounts are never captured or completed as finished transactions and therefore no funds are ever transferred to or from the cardholder's account.

Element 102 then receives the consumer's input to confirm the amounts of each individual authorization generated by element 100. Element 104 then determines whether the consumer input has correctly confirmed the amount of each authorization request (as well as the number of requests). If so, element 106 identifies the consumer as an authorized cardholder for this card account. Such a confirming message is constructed and returned to the requesting merchant by operation of element 110.

If element 104 determines that the consumer has not supplied proper confirmation of the amount of each individual authorization request, element 108 identifies the consumer as an unauthorized cardholder or user. Element 110 then returns such a message to the requesting merchant.

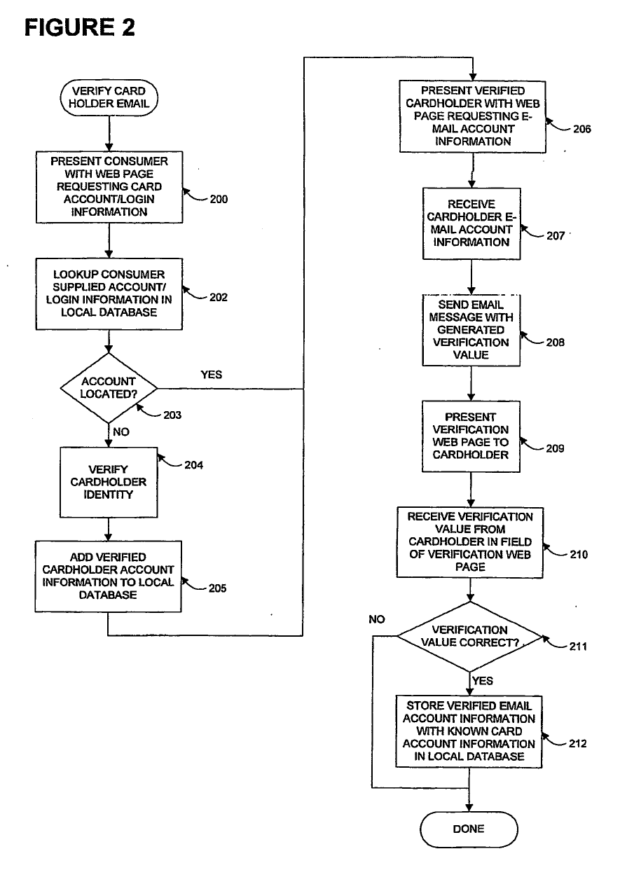

FIG. 2 is a flowchart describing a method of the present invention operable within a local verification services system to verify the e-mail account for an authorized cardholder or user. In an exemplary preferred embodiment, the method of FIG. 2 interacts with the user via standard Internet features including e-mail, HTTP Web browsing or mobile communication protocols (such as WAP).

Element 200 is first operable to present the consumer with a Web page requesting card account/login information. Element 202 is then operable to lookup account information using the identified card account number in the local database associated with the local verification services system. Element 203 then determines whether the identified card account is already known to the local verification services system (i.e., found in the local database). If the account is already known to the system (i.e., located in he local database), processing continues at element 206 as discussed below. If the identified account number is not presently known to the local verification services system, elements 204 and 205 are operable to perform appropriate verification processes as described above and to store such verified information in the local database maintained by the local verification services system. In particular, element 204 is operable to verify the cardholder's identity as discussed above with respect to FIG. 1. After properly verifying the cardholder's authenticity, element 205 is then operable to store such verified account information in the local database associated with the local verification services system. Processing then continues at element 206 as discussed further below.

Element 206 is operable to present the verified and known cardholder with a Web page requesting the cardholder's e-mail account information. Element 207 receives such information from the cardholder. Element 208 then generates an e-mail message to the provided e-mail account. In an exemplary preferred embodiment the e-mail message includes a randomly generated verification value. Element 209 then presents the cardholder with a second Web page requesting that the cardholder returns in a field of the second Web page the randomly generated verification value transmitted to the cardholder's identified e-mail account. Element 210 is then operable to receive the e-mail verification values from the cardholder. Element 211 then verifies that the correct verification value has been returned by the cardholder indicating that the e-mail account is properly associated with the verified cardholder account. If so, element 212 stores the verified e-mail account information with the known cardholder account information in a local database. As discussed further herein below, the verified e-mail account may then be used to verify a proposed transaction from the known cardholder at the request of a merchant.

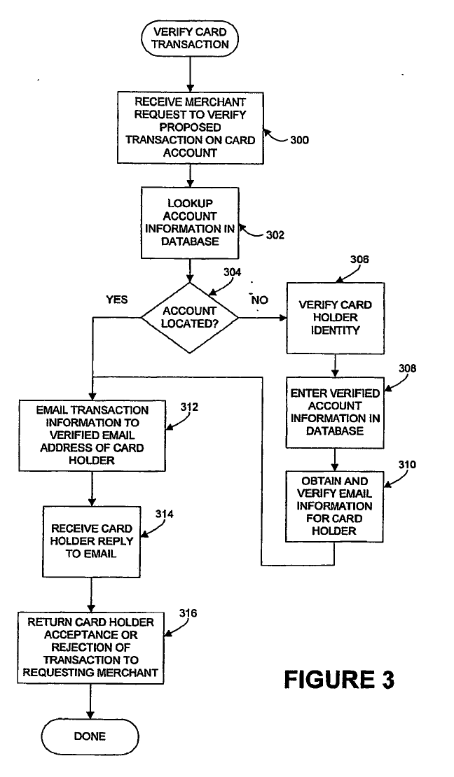

FIG. 3 is a flowchart describing a method of the present invention operable within a local verification services system to verify a particular proposed purchase transaction associated with a verified financial card account. Information for the verified card account is preferably stored in the database of the local verification services system.

Element 300 is first operable to receive a request from a merchant to verify a proposed purchase transaction using an identified card account. Element 302 is then operable to lookup account information using the identified card account number in the local database associated with the local verification services system. Element 304 then determines whether the identified card account is already known to the local verification services system (i.e., found in the local database). If the identified account number is not presently known to the local verification services system, element 306 through 310 are operable to perform appropriate verification processes as described above and to store such verified information in the local database maintained by the local verification services system. In particular, element 306 is operable to verify the consumer's identity as discussed above with respect to FIG. 1. After properly verifying the cardholder's authenticity, element 308 is then operable to store such verified account information in the local database associated with the local verification services system. Element 310 then obtains a verified e-mail account to be associated with the verified and known cardholder account information as discussed above with respect to FIG. 2. Such a verified e-mail account information is stored in the local database associated with the verified card information. Processing then continues at element 312 as discussed further below.

If element 304 determines that the identified card account is already known to the local verification services system (i.e., found in the local database), processing continues with element 312 to e-mail the proposed transaction information to the known e-mail account of the known cardholder. Element 314 then receives an e-mail reply from the authorized, verified cardholder indicating the cardholder's acceptance or rejection of the proposed transaction. The cardholder's acceptance or rejection of the transaction is then returned to the requesting merchant to permit the merchant to determine whether to complete the proposed transaction.

While the invention has been illustrated and described in the drawings and foregoing description, such illustration and description is to be considered as exemplary and not restrictive in character, it being understood that only the preferred embodiment and minor variants thereof have been shown and described and that all changes and modifications that come within the spirit of the invention are desired to be protected.

1. A method for authenticating the identity of a consumer as an authorized cardholder of a financial card account comprising the steps of:
issuing at least one card authorization request for said financial card account wherein the amount of each authorization request is randomly selected;
receiving information from said consumer regarding each of said at least one authorization request; and
verifying said consumer as said authenticated cardholder in response to receipt of correct information regarding said each of said at least one authorization request.

2. The method of claim 1 wherein the step of receiving said information comprises the step of:
receiving information regarding the amount of said each of said at least one authorization request.

3. The method of claim 1 wherein the step of receiving said information comprises the step of:
receiving information regarding the number of authorization requests issued of said at least one authorization request.

4. The method of claim 1 wherein the step of receiving said information comprises the step of:
receiving information regarding the total amount of the sum of the amount of said each of said at least one authorization request.

5. The method of claim 1 wherein the step of issuing comprises the step of:
issuing two authorization requests to said identified electronic account wherein the amount of each authorization request is randomly selected and the total amount of said two authorization requests equals a predetermined amount.

6. A method for authenticating the identity of a consumer as an authorized cardholder of a financial card account comprising the steps of:
dynamically generating a temporary identification code;
locating, in a database, information regarding said financial card account wherein said information includes an e-mail account owned by said authorized cardholder;
sending an e-mail message to said e-mail account in response to locating said information, wherein said message includes said temporary identification code and wherein said message requests the e-mail message recipient to validate said card transaction request; and
receiving a reply from a user of said e-mail account indicating acceptance or rejection of said card transaction, wherein said reply includes said randomly generated information, and
wherein the step of authenticating comprises the steps of:
determining whether said randomly generated information in said reply matches said randomly generated information in said message; and
validating said card transaction in response to receipt of said reply indicating acceptance of said card transaction and in response to a determination that said randomly generated information in said message and in said reply match.

7. The method of claim 6 wherein in response to failure to locate said information in said database, the method further comprises the steps of:
verifying the identity of said authorized cardholder;
obtaining an e-mail account to be associated with said financial card account; and
verifying said e-mail account as associated with said authorized cardholder.

8. The method of claim 7 wherein the step of verifying the identity of said cardholder comprises the steps of:
issuing at least one card authorization request on said financial card account wherein the amount of each authorization request is randomly selected;
receiving from said consumer information regarding each of said at least one authorization request; and
verifying the identity of said consumer as an authenticated cardholder in response to receipt of correct information regarding said each of said at least one authorization request.

9. The method of claim 8 wherein the step of receiving said information comprises the step of:
receiving information regarding the amount of said each of said at least one authorization request.

10. The method of claim 8 wherein the step of receiving said information comprises the step of:
receiving information regarding the number of authorization requests issued of said at least one authorization request.

11. The method of claim 8 wherein the step of receiving said information comprises the step of:
receiving information regarding the total amount of the sum of the amount of said each of said at least one authorization request.

12. The method of claim 8 wherein the step of issuing comprises the step of:
issuing two authorization requests to the financial card account wherein the amount of each authorization request is randomly selected and the total amount of said two authorization requests equals a predetermined amount.

13. The method of claim 8 wherein the step of verifying said e-mail account comprises the steps of:
presenting a Web page to a user of said e-mail account;
sending an e-mail message to said e-mail account wherein said message includes an authorization code; and
receiving said authorization code from said user in a field of said Web page.

14. A system for authenticating the identity of a consumer as an authorized cardholder of a financial card account comprising:
means for issuing at least one card authorization request for said financial card account wherein the amount of each authorization request is randomly selected;
means for receiving information from said consumer regarding each of said at least one authorization request; and
means for verifying said consumer as said authenticated cardholder in response to receipt of correct information regarding said each of said at least one authorization request.

15. The system of claim 14 wherein the means for receiving said information comprises:
means for receiving information regarding the amount of said each of said at least one authorization request.

16. The system of claim 14 wherein the means for receiving said information comprises:
means for receiving information regarding the number of authorization requests issued of said at least one authorization request.

17. The system of claim 14 wherein the means for receiving said information comprises:
means for receiving information regarding the total amount of the sum of the amount of said each of said at least one authorization request.

18. The system of claim 14 wherein the means for issuing comprises:
means for issuing two authorization requests to said identified electronic account wherein the amount of each authorization request is randomly selected and the total amount of said two authorization requests equals a predetermined amount.
